(19) United States
(12) Patent Application Publication
(10) Pub. No.: US 2010/0218210 A1
(43) Pub. Date: Aug. 26, 2010

(54) EMERGENCY BROADCAST SYSTEM

(75) Inventor: Vladimir Smelyansky, Glenview, IL (US)

Correspondence Address: Hanify & King Professional Corporation, 1055 Thomas Jefferson Street, NW, Suite 400, WASHINGTON, DC, 20007, US

(73) Assignee: XCAST LABS, INC., Northfield, IL (US)

(21) Appl. No.: 12/710,002

(22) Filed: Feb. 22, 2010

Related U.S. Application Data
(60) Provisional application No. 61/154,467, filed on Feb. 23, 2009.

(51) Int. Cl. H04N 7/025; H04M 11/04

(52) U.S. Cl. 725/33; 379/48

(57) ABSTRACT

A method, system, and computer program product for emergency broadcasting to telephones or audio and/or video-enabled devices from a server system provide more timely emergency notification and more effective coverage for such emergency notifications than existing systems. A method for broadcasting at least one message to end user devices may comprise determining at least one group including a plurality of end user devices to which to broadcast the at least one message, based on programmable criteria related to each end user device and independently of a private branch exchange, central office, or other physical connection of each end user device, and transmitting the at least one message to each end user device of the group of end user devices.

### CROSS-REFERENCE TO RELATED APPLICATIONS

This application claims the benefit of Provisional Application No. 61/154,467, filed Feb. 23, 2009, the contents of which are incorporated herein in their entirety.

### BACKGROUND OF THE INVENTION

1. Field of the Invention

The present invention relates to a method, system, and computer program product for providing emergency broadcasting to telephones or audio and/or video-enabled devices from a server system.

2. Description of the Related Art

In case of emergencies in the public arena, currently there are a number of different emergency notification techniques, such as TV and radio broadcasts, sirens, etc. However, these methods reach only a small portion of the population in any real-time or near real-time framework. Since most people are working most of their waking hours and not likely to be watching TV or listening to emergency broadcasts, currently, they receive emergency alerts in episodic and untimely ways. For example, if there is a bomb threat or shooter on a campus, or if a tornado is forming in an area, a typical person would likely first learn of the event by looking out the window or hearing about it on the evening news. Thus, current emergency notification techniques provide haphazard and untimely notification of emergencies. A need arises for a technique that will provide more timely emergency notification and more effective coverage for such emergency notifications.

### SUMMARY OF THE INVENTION

A method, system, and computer program product for emergency broadcasting to telephones or audio and/or video-enabled devices from a server system provide more timely emergency notification and more effective coverage for such emergency notifications than existing systems. This new technology provides targeted announcements to all offices or other locations based on programmable criteria, such as locations, time, type of emergency, etc. A system enabled with this technology is communicatively connected to emergency services and can automatically deliver internal emergency alerts. End user phones that are connected to the system have the capability to automatically answer calls from the system on their speaker phones. This capability may also be extended to intercoms and pagers. The system knows the location and type of associated end user devices. When local, regional, or national emergencies are imminent, e.g., hurricanes or tornadoes, the system can send messages to PC's or to phones as controlled by the server.

For example, a method for broadcasting at least one message to end user devices may comprise determining at least one group including a plurality of end user devices to which to broadcast the at least one message, based on programmable criteria related to each end user device and independently of a private branch exchange, central office, or other physical connection of each end user device, and transmitting the at least one message to each end user device of the group of end user devices. Each end user device of the group of end user devices may be configured to automatically receive the message. Each end user device of the group of end user devices may be configured to automatically play the message to an end user. The at least one message may be transmitted from a central server.

The determining step may comprise the step of automatically determining the at least one group of end user devices based on at least one of a geographic location of an end user device, a political location of an end user device, a physical location of an end user device, and a type or content of the at least one message. The at least one message may be transmitted using Session Initiation Protocol. The end user devices may include at least one of a hardware telephone, a software telephone, and a computer system. At least some end user devices of the group of end user devices may be configured to automatically receive the message and play the message to an end user. The configured end user devices may be configured using a SIP INVITE message.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary diagram of block diagram of a network system in which the present invention may be implemented.

FIG. 2 is an exemplary flow diagram of a process of emergency message broadcasting

FIG. 3 is an exemplary block diagram of a computer system, such as a Messaging server, in which the present invention may be implemented.

### DETAILED DESCRIPTION OF THE INVENTION

A method, system, and computer program product for emergency broadcasting from to telephones or audio and/or video-enabled devices from a server system provide more timely emergency notification and more effective coverage for such emergency notifications than existing systems. This new technology provides targeted announcements to all offices or other locations based on programmable criteria, such as locations, time, type of emergency, etc. A system enabled with this technology is communicatively connected to emergency services and can automatically deliver internal emergency alerts. End user phones that are connected to the system have the capability to automatically answer calls from the system on their speaker phones. This capability may also be extended to intercoms and pagers. The system knows the location and type of associated end user devices. When local, regional, or national emergencies are imminent, e.g., hurricanes or tornadoes, the system can send messages to PC's or to phones as controlled by the server.

It is to be noted that while some conventional Private Branch Exchanges (PBXs) have intercom capability, this capability is limited to each PBX. That is, intercom connections can only be established among phones connected to the same PBX. By contrast, the new technology described in this document provides the capability to group end user devices based on programmable criteria, such as such as location, time, type of emergency, etc., independently of the PBXs or central office (CO) switches to which the end user devices may be connected. This new feature provides the capability, for example, to broadcast a message to all end user devices in an office building containing a number of companies having different PBXs, or to broadcast a message to all end user devices in a geographic area containing a number of companies and residents connected via a number of different PBXs and CO switches.

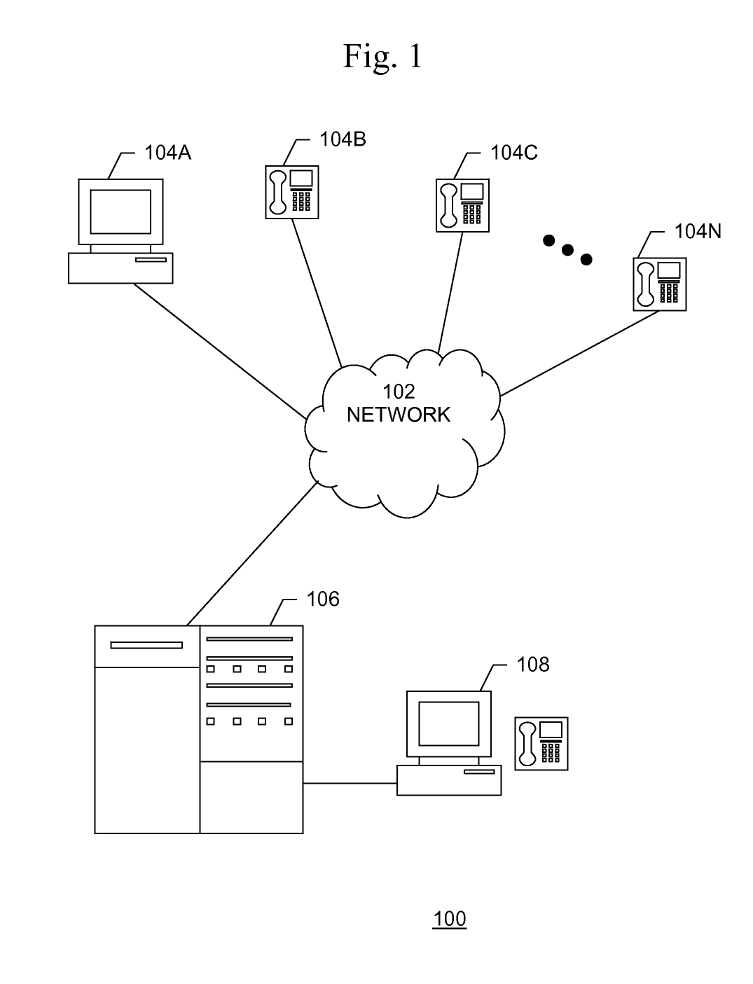

As an example, such features may be provided in a network system 100, such as that shown in FIG. 1. FIG. 1 shows a network 102, a plurality of end user devices 104A-N, a Messaging server 106, and an administrative workstation 108. Network 102 typically is, or includes the Internet, but may include any communications network that is now in service or which may be developed in the future. Such a network may include one or more public or private communications networks, such as the Internet, wired or wireless telephone networks, wired or wireless data networks, local area networks, etc. End user devices 104A-N include any device capable of transmitting audio and/or video to an end user, such as a hardware telephone, such as telephone 104B, or a software based phone client running on a computer system, such as computer system 104A. Messaging server 106 is a server computer system that keeps track of all end user devices, generates and sends appropriate broadcast messages. Messaging server 106 may be included in, or connected to, a telephone Private Branch Exchange (PBX), a telephone Central Office (CO), a Voice-over-Internet Protocol (VoIP) switch, etc. Messaging server 106 provides an interface, such as a web or command line interface, with which an administrator using administrative workstation 108 may manage and Messaging server 106 and may control sending of the broadcast messages.

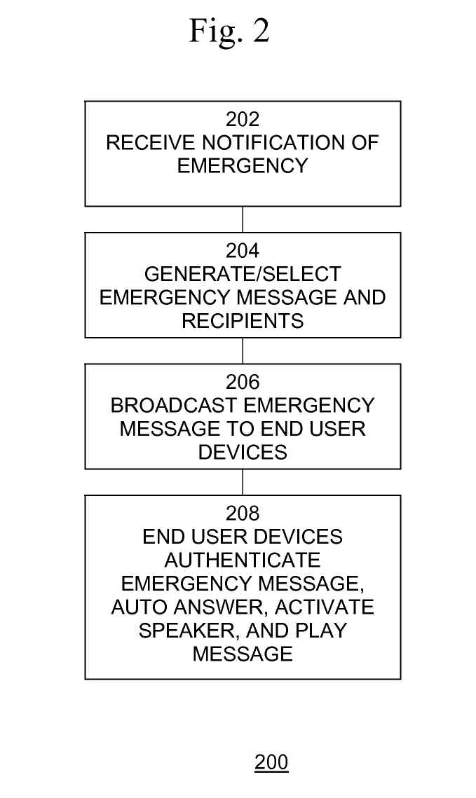

An exemplary flow diagram of a process 200 of emergency broadcasting is shown in FIG. 2. It is best viewed in conjunction with FIG. 1. Process 200 begins with step 202, in which an administrator, system operator, or the system itself receives notification of an emergency. Upon determining that the emergency necessitates broadcast of an emergency message, the administrator or system operator uses administrative workstation 108 to cause Messaging server 106 to perform the emergency broadcast. Although typically, notification of an emergency is received by a person, such as the administrator or system operator, who determines whether or not the emergency necessitates broadcast of an emergency message, it is also possible that Messaging server 106 may be directly notified of an emergency. In this case, Messaging server 106 would process the notification by applying a predefined or programmable rule-based analysis. Possible outcomes from this analysis may include, for example, Messaging server 106 automatically initiating the emergency broadcast, automatically determining not to initiate the emergency broadcast, or notifying the administrator or system operator for further determination.

In step 204, the administrator or system operator using administrative workstation 108 and/or Messaging server 106 generates or selects one or more emergency messages to be broadcast and also the end user recipients for each message. For example, the administrator or system operator may record an emergency message to be broadcast using administrative workstation 108 and transmit this recorded message to Messaging server 106 for broadcast. As another example, either administrative workstation 108 or Messaging server 106, or both, may store a number of pre-recorded emergency messages. In this case, the administrator or system operator, or Messaging server 106 itself, may select one or more of the pre-recorded emergency messages to be broadcast. Any selected messages stored in administrative workstation 108 would, of course, be transmitted to Messaging server 106 for broadcast.

Likewise, the end users that are to receive each of the messages are selected. This may be done by the administrator or system operator using administrative workstation 108 or by Messaging server 106 using a rule-based analysis of information about the emergency. For example, in the case of an emergency in a particular building on a campus, an emergency message may be broadcast to the occupants of the affected building instructing them to evacuate the building, while an emergency message may be broadcast to the occupants of the building that are not affected instructing them to remain indoors. The messages and the recipients for each message may be determined by the administrator or system operator using administrative workstation 108 and transmitted to Messaging server 106, or the messages and the recipients for each message may be determined by Messaging server 106 using a rule-based analysis of information about the emergency. In addition, messages to be broadcast to each end user device may be selected based on the capabilities of the end user device. For example, an audio only message may be selected to be broadcast to hardware telephones, while an audio/video message may be selected to be broadcast to a video phone or a computer.

In order to provide the capability to create and forward messages to selected lists of end user devices, such as end user devices 104A-N, and to create the list of end user devices, Messaging server 106 and/or administrative workstation 108 provides a human interface for the administrator or system operator. This may be provided over a web interface with the ability to upload audio and/or video files, for example. Messaging server 106 and/or administrative workstation 108 may likewise provide logic that automatically creates and forwards messages to selected lists of end user devices and that creates the list of end user devices. For example, Messaging server 106 includes a database that associates end user devices with their geographical locations and may select all devices that have addresses in a particular zip code area.

In step 206, Messaging server 106 broadcasts the recorded and/or selected emergency message to the end user devices of the selected recipients, such as end user devices 104A-N. For example, Messaging server 106 may transmit SIP INVITE messages to each selected end user device. An example of such a SIP INVITE message is:

INVITE sip:7065D02L01@10.10.10.129:5060 SIP/2.0
Via: SIP/2.0/UDP 38.102.250.16:7060;branch=z9hG4bK-middle-3885742-102.0
Via: SIP/2.0/UDP 38.102.250.16:5060;branch=z9hG4bK-xcast-dO1aMHFKP2.0
Via: SIP/2.0/UDP 38.102.250.16:5080;branch=z9hG4bK011d73ec
Record-Route: <sip:3885742@38.102.250.16:7060;lr>
Record-Route: <sip:intercom@38.102.250.16:5060;lr;xft=as039e312d>
From: “Emergency Admin“ <sip:7065@38.102.250.16:5080>;tag=as039e312d
To: <sip:px-callblasttui-8067-8064@38.102.250.16>
Contact: <sip:intercom@38.102.250.16:5080>
Call-ID: 4900c56d629a982d7e9a3b132c1a6c39@38.102.250.16
CSeq: 102 INVITE
User-Agent: SIPTalk Media Server
Content-Type: application/sdp
Content-Length: 379
Date: Wed, 10 Feb 2010 20:55:53 GMT
Call-Info: <sip:xcast>;answer-after=0
Alert-Info: <sip:xcast>;info=alert-autoanswer;delay=0
Allow: INVITE, ACK, CANCEL, OPTIONS, BYE, REFER
v=0
o=middle 3885742 102 IN IP4 38.102.250.16
s=session
c=IN IP4 38.102.250.16
t=0 0
m=audio 43638 RTP/AVP 0 8 18 4 3 101
a=rtpmap:0 PCMU/8000
a=rtpmap:8 PCMA/8000
a=rtpmap:18 G729/8000
a=rtpmap:4 G723/8000
a=rtpmap:3 GSM/8000
a=rtpmap:101 telephone-event/8000
a=fmtp:101 0-16
a=ptime:20

The Call-Info and Alert-Info lines in the exemplary SIP INVITE message above instruct the receiving end user device to immediately auto-answer the call being set up by the SIP INVITE message. Although there is no definitive information in the SIP RFC (RFC 3261) that states how devices should react to these messages, it has become a de-facto industry standard for devices to immediately auto-answer the call in response to such a message. Some devices support the Call-Info line, while others support the Alert-Info line, while still others support both lines. It has been found that sending both lines does no harm and works with the majority of devices. Sending both lines eliminates the need to remember which device supports what, especially given that end users can do firmware upgrades or even replace the actual physical device. In any case, this is merely an example of a SIP INVITE message that may be used.

In step 208, upon receipt of the SIP INVITE message, each end user device authenticates the message, that is, determines that it is legitimate, auto-answers the call, as described above, actives the end user device speaker and plays the message. In this way, emergency messages may be broadcast to the selected end user devices.

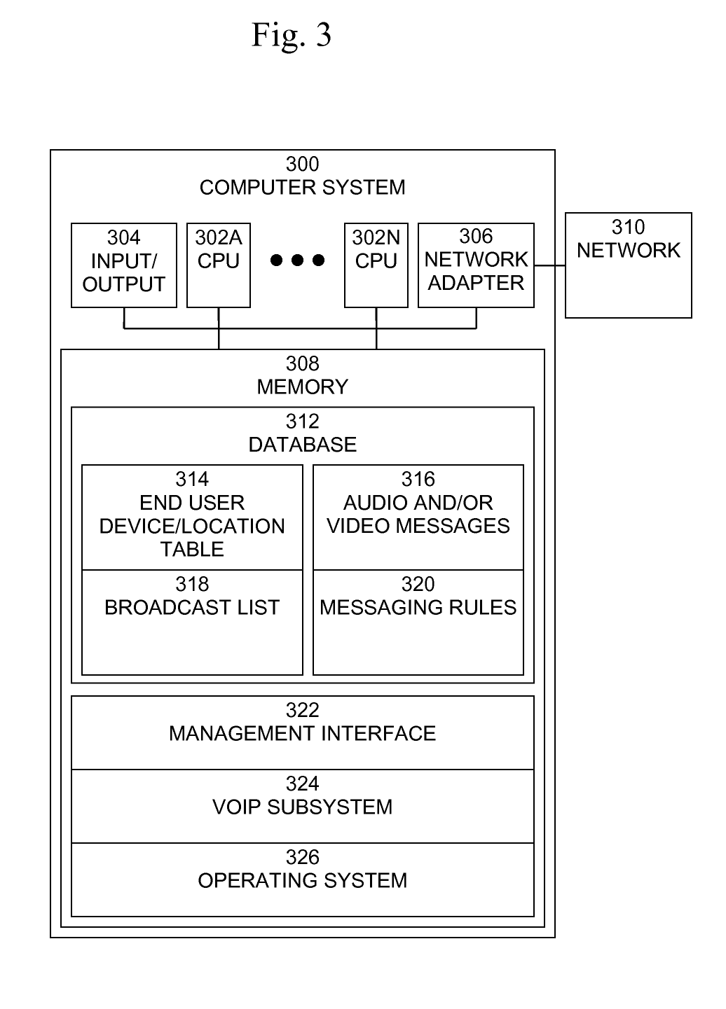

An exemplary block diagram of a computer system 300, such as a Messaging Server, is shown in FIG. 3. System 300 is typically a programmed general-purpose computer system, such as a personal computer, workstation, server system, and minicomputer or mainframe computer. System 300 includes one or more processors (CPUs) 302A-302N, input/output circuitry 304, network adapter 306, and memory 308. CPUs 302A-302N execute program instructions in order to carry out the functions of the present invention. Typically, CPUs 302A-302N are one or more microprocessors, such as an INTEL PENTIUM® processor. FIG. 3 illustrates an embodiment in which System 300 is implemented as a single multi-processor computer system, in which multiple processors 302A-302N share system resources, such as memory 308, input/output circuitry 304, and network adapter 306. However, the present invention also contemplates embodiments in which system 300 is implemented as a plurality of networked computer systems, which may be single-processor computer systems, multi-processor computer systems, or a mix thereof.

Input/output circuitry 304 provides the capability to input data to, or output data from, database/system 300. For example, input/output circuitry may include input devices, such as keyboards, mice, touchpads, trackballs, scanners, etc., output devices, such as video adapters, monitors, printers, etc., and input/output devices, such as, modems, etc. Network adapter 306 interfaces device 300 with network 310. Network 310 includes any communications network that is now in service or which may be developed in the future. Such a network may include one or more public or private communications networks, such as the Internet, wired or wireless telephone networks, wired or wireless data networks, local area networks, etc.

Memory 308 stores program instructions that are executed by, and data that are used and processed by, CPU 302 to perform the functions of system 300. Memory 308 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface, or Serial AT Attachment (SATA), or a variation or enhancement thereof.

The contents of memory 308 varies depending upon the function that system 300 is programmed to perform. For example, where system 300 is a Messaging Server, memory 308 includes database 312, which includes end user device/location table 314, audio and/or video messages 316, broadcast list 318, and messaging rules 320. End user device/location table 314 associates each end user device with a geographic, political, or physical location, and may, in addition, store information about the characteristics of each end user device, such as the type of device, the capabilities of the device, etc. Audio and/or video messages 316 include messages that may be broadcast to end user devices that have been prerecorded or which have been received from, for example, an administrative workstation. Broadcast list 318 includes a list of end user devices that have been selected to for broadcast of messages, and may include individual or group indications of messages to be broadcast. Messaging rules 320 include rules that provide the system with the capability to determine whether or not to broadcast emergency messages and to select end user devices for broadcast of messages. In addition, memory 308 includes management interface 322 and VoIP subsystem 324. Management interface 322 provides the capability for the system to be managed and controlled, either from an administrative workstation, or depending upon security measures, any network and/or Internet connected computer system. VoIP subsystem 324 provides the capability to transmit the messages to the end user devices using VoIP, or with the use of a gateway, over the Public Switched Telephone Network (PSTN). Operating system 326 provides overall system functionality.

As shown in FIG. 3, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable storage media include, floppy disks, hard disk drives, CD-ROMs, DVDROMs, RAM, flash memory, etc.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for broadcasting at least one message to end user devices comprising:
determining at least one group including a plurality of end user devices to which to broadcast the at least one message, based on programmable criteria related to each end user device and independently of a private branch exchange, central office, or other physical connection of each end user device; and
transmitting the at least one message to each end user device of the group of end user devices.

2. The method of claim 1, wherein each end user device of the group of end user devices is configured to automatically receive the message.

3. The method of claim 2, wherein each end user device of the group of end user devices is configured to automatically play the message to an end user.

4. The method of claim 1, wherein the at least one message is transmitted from a central server.

5. The method of claim 1, wherein the determining step comprises the step of:
automatically determining the at least one group of end user devices based on at least one of a geographic location of an end user device, a political location of an end user device, a physical location of an end user device, and a type or content of the at least one message.

6. The method of claim 5, wherein the at least one message is transmitted using Session Initiation Protocol.

7. The method of claim 6, wherein the end user devices include at least one of a hardware telephone, a software telephone, and a computer system.

8. The method of claim 7, wherein at least some end user devices of the group of end user devices are configured to automatically receive the message and play the message to an end user.

9. The method of claim 8, wherein the configured end user devices are configured using a SIP INVITE message.

10. A computer program product for broadcasting at least one message to end user devices comprising a computer readable storage medium and computer program instructions, recorded on the computer readable medium and executable by a processor, for performing the steps of:
determining at least one group including a plurality of end user devices to which to broadcast the at least one message, based on programmable criteria related to each end user device and independently of a private branch exchange, central office, or other physical connection of each end user device; and
transmitting the at least one message to each end user device of the group of end user devices.

11. The computer program product of claim 10, wherein each end user device of the group of end user devices is configured to automatically receive the message.

12. The computer program product of claim 11, wherein each end user device of the group of end user devices is configured to automatically play the message to an end user.

13. The computer program product of claim 10, wherein the at least one message is transmitted from a central server.

14. The computer program product of claim 10, wherein the determining step comprises the step of:
automatically determining the at least one group of end user devices based on at least one of a geographic location of an end user device, a political location of an end user device, a physical location of an end user device, and a type or content of the at least one message.

15. The computer program product of claim 14, wherein the at least one message is transmitted using Session Initiation Protocol.

16. The computer program product of claim 15, wherein the end user devices include at least one of a hardware telephone, a software telephone, and a computer system.

17. The computer program product of claim 16, wherein at least some end user devices of the group of end user devices are configured to automatically receive the message and play the message to an end user.

18. The computer program product of claim 17, wherein the configured end user devices are configured using a SIP INVITE message.

19. A system for broadcasting at least one message to end user devices comprising a processor operable to execute computer program instructions, a memory operable to store computer program instructions executable by the processor, and computer program instructions stored in the memory and executable to perform the steps of:
determining at least one group including a plurality of end user devices to which to broadcast the at least one message, based on programmable criteria related to each end user device and independently of a private branch exchange, central office, or other physical connection of each end user device; and
transmitting the at least one message to each end user device of the group of end user devices.

20. The system of claim 19, wherein each end user device of the group of end user devices is configured to automatically receive the message.

21. The system of claim 20, wherein each end user device of the group of end user devices is configured to automatically play the message to an end user.

22. The system of claim 19, wherein the at least one message is transmitted from a central server.

23. The system of claim 19, wherein the determining step comprises the step of:
automatically determining the at least one group of end user devices based on at least one of a geographic location of an end user device, a political location of an end user device, a physical location of an end user device, and a type or content of the at least one message.

24. The system of claim 23, wherein the at least one message is transmitted using Session Initiation Protocol.

25. The system of claim 24, wherein the end user devices include at least one of a hardware telephone, a software telephone, and a computer system.

26. The system of claim 25, wherein at least some end user devices of the group of end user devices are configured to automatically receive the message and play the message to an end user.

27. The system of claim 26, wherein the configured end user devices are configured using a SIP INVITE message.
